(19) United States
(12) Patent Application Publication
(10) Pub. No.: US 2026/0003770 A1
(43) Pub. Date: Jan. 1, 2026

(54) SYSTEMS AND METHODS FOR TESTING, VALIDATING, AND OPTIMIZING SOFTWARE

(71) Applicant: AT&T Intellectual Property I, L.P., Atlanta, GA (US)

(72) Inventors: Richard C. Cook, Canton, GA (US); Mitchell Gunnels, Ball Ground, GA (US); Preston Landell, Pace, FL (US); Prakash Bigamudra, Cumming, GA (US); Samar Griffin, Shiloh, IL (US); Karthic Raghavan, Redmond, WA (US)

(73) Assignee: AT&T Intellectual Property I, L.P., Atlanta, GA (US)

(21) Appl. No.: 18/758,708

(22) Filed: Jun. 28, 2024

(51) Int. Cl. G06F 11/36; G06F 11/34

(52) U.S. Cl. CPC G06F 11/3688; G06F 11/3428; G06F 11/3684

(57) ABSTRACT

Aspects of the subject disclosure may include, for example, obtaining first information indicative of function(s) that a software application is designed to be capable of performing; obtaining second information indicative of acceptance criteria that define whether the software application has performed the function(s); generating (based upon the first and second information) a first prompt configured for input to a generative artificial intelligence (AI) mechanism; inputting the first prompt to the generative AI mechanism; receiving at least one test plan that was generated by the generative AI mechanism; and facilitating execution of the software application based upon the test plan. Other embodiments are disclosed.

### FIELD OF THE DISCLOSURE

The subject disclosure relates to systems and methods for testing, validating, and optimizing software.

### BACKGROUND

A certain conventional process involves manual test plan creation and subsequent generation of automation test scripts in Agile software development as well as manually correcting a failed automation test script during execution. This conventional process is often time consuming and often requires significant human intervention and expertise (leading to increased costs and potential for human error). Additionally, as projects evolve, maintaining and updating test plans and test scripts can be challenging, and can delay the overall development process.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a process functioning in accordance with various aspects described herein.

FIG. 2 is a block diagram illustrating an example, non-limiting embodiment of a process functioning in accordance with various aspects described herein.

FIG. 3A depicts an illustrative embodiment of a method in accordance with various aspects described herein.

FIG. 3B depicts an illustrative embodiment of a method in accordance with various aspects described herein.

FIG. 3C depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for testing, validating, and optimizing software. Other embodiments are described in the subject disclosure.

One or more aspects of the subject disclosure include embodiments that: (a) utilize generative artificial intelligence (AI) to automatically create test plans (e.g., with multiple test cases) based on user stories and acceptance criteria; (b) then (e.g., after human review), take the generated test plans and utilize generative AI to produce automation test scripts; (c) then, during automation test script execution (if an error is detected), send the error to the generative AI to help identify the issue and/or suggest a resolution; and (d) then have the system re-run the automation test script. Such automation (according to various embodiments) can significantly reduce manual efforts and streamline the software testing process. As Agile methodology continues to dominate the industry, the demand for efficient and cost-effective testing strategies will only grow. By incorporating AI-driven automation (according to various embodiments) in both test plan creation and subsequent automation test script generation and execution, a predictive and scalable solution is provided that can adapt to the evolving needs of the software development landscape.

One or more aspects of the subject disclosure include a device, comprising: a processing system including a processor; and a memory that stores executable instructions that, when executed by the processing system, facilitate performance of operations, the operations comprising: obtaining first information indicative of one or more functions that a software application is designed to be capable of performing; obtaining second information indicative of one or more acceptance criteria that define whether the software application has performed the one or more functions; generating a first prompt configured for input to a generative artificial intelligence (AI) mechanism, wherein the generating of the first prompt is based at least in part upon the first information and the second information; facilitating input of the first prompt to the generative AI mechanism; responsive to the input of the first prompt to the generative AI mechanism, receiving at least one test plan that was generated by the generative AI mechanism; and facilitating execution of the software application based upon the test plan, wherein the execution of the software application results in a performance report.

One or more aspects of the subject disclosure include a non-transitory machine-readable medium comprising executable instructions that, when executed by a processing system including a processor, facilitate performance of operations, the operations comprising: obtaining at least one test plan that was generated by a first generative artificial intelligence (AI) mechanism, wherein the test plan is associated with a software application; facilitating execution of the software application based upon the test plan, wherein the execution of the software application results in performance data; and facilitating a healing process to rectify at least one error associated with execution of an automated test script against the software application, wherein healing process comprises: obtaining first information indicative one or more failed locators associated with the software application; generating a first prompt configured for input to a second generative AI mechanism, wherein the generating of the first prompt is based at least in part upon the first information indicative of the one or more failed locators; facilitating input of the first prompt to the second generative AI mechanism; and responsive to the input of the first prompt to the second generative AI mechanism, receiving at least one new locator that was generated by the second generative AI.

One or more aspects of the subject disclosure include a method, comprising: obtaining, by a processing system including a processor, function information that indicates at least one function that a software program is designed to be capable of performing; obtaining, by the processing system, at least one acceptance benchmark that defines whether the software program has performed the at least one function; generating, by the processing system, a first prompt configured for input to a first generative artificial intelligence (AI) process, wherein the generating of the first prompt is based at least in part upon the function information and the acceptance information; facilitating, by the processing system, input of the first prompt to the first generative AI process; responsive to the input of the first prompt to the first generative AI process, receiving, by the processing system, at least one test case that was generated by the first generative AI process; generating, by the processing system, a second prompt configured for input to a second generative AI process, wherein the generating of the second prompt is based at least in part upon the at least one test case; facilitating, by the processing system, input of the second prompt to the second generative AI process; responsive to the input of the second prompt to the second generative AI process, receiving, by the processing system, a test script that was generated by the second generative AI process; facilitating, by the processing system, execution of the software program based upon the test script, wherein the execution of the software program results in a performance report; and outputting, by the processing system, the performance report.

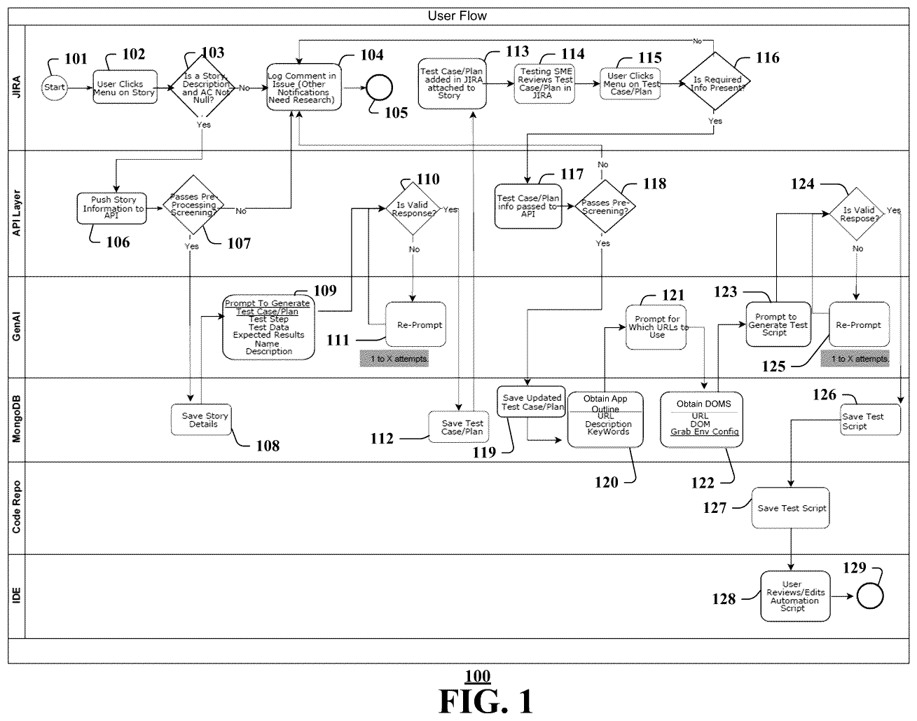

Referring now to FIG. 1, this is a block diagram illustrating an example, non-limiting embodiment of a user flow process 100 functioning in accordance with various aspects described herein. As seen in this figure, the user flow process 100 starts at element 101 (Start). The process then continues to element 102 (User Clicks Menu on Story) and from there to element 103 (Is a Story Description and AC (Acceptance Criteria) Not Null?). If, at element 103, the result is “No”, then the process continues to element 104 (Log Comment in Issue (Other Notifications Need Research)) and from there to element 105 (End). On the other hand, if, at element 103, the result is “Yes”, then the process continues to element 106 (Push Story Information to API) and from there to element 107 (Passes Pre-Processing Screening?). If, at element 107, the result is “No”, then the process continues to element 104 (whereafter the process continues as described above). On the other hand, if, at element 107, the result is “Yes”, then the process continues to element 108 (Save Story Details).

Still referring to FIG. 1, from element 108, the process continues to element 109 (Prompt To Generate Test Case/Plan (including Test Step(s), Test Data, Expected Results, Name, and Description) and from there to element 110 (Is Valid Response?). If, at element 110, the result is “No”, then the process continues to element 111 (Re-Prompt) and from there back to element 110 (this iterative re-prompting can be carried out any desired number of times in order to try to achieve a valid response at element 110). On the other hand, if, at element 110, the result is “Yes”, then the process continues to element 112 (Save Test Case/Plan).

Still referring to FIG. 1, from element 112, the process continues to element 113 (Test Case/Plan added in JIRA attached to Story) and from there to element 114 (Testing Subject Matter Expert (SME) Reviews Test Case/Plan in JIRA). Further, from element 114 the process continues to element 115 (User Clicks Menu on Test Case/Plan) and from there to element 116 (Is Required Info Present?). If, at element 116, the result is “No”, then the process continues to element 104 (whereafter the process continues as described above). On the other hand, if, at element 116, the result is “Yes”, then the process continues to element 117 (Test Case/Plan Info Passed to API).

Still referring to FIG. 1, from element 117, the process continues to element 118 (Passes Pre-Screening?) If, at element 118, the result is “No”, then the process continues to element 104 (whereafter the process continues as described above). On the other hand, if, at element 118, the result is “Yes”, then the process continues to element 119 (Save Updated Test Case/Plan) and from there to element 120 (Obtain App Outline (including URL, Description, Keywords)). Further, from element 120 the process continues to element 121 (Prompt for Which URLs to Use) and from there to element 122 (Obtain App DOMS (including URL, DOM) and Grab Env Config)). Further still, from element 122 the process continues to element 123 (Prompt to Generate Test Script) and from there to element 124 (Is Valid Response?). If, at element 124, the result is “No”, then the process continues to element 125 (Re-Prompt) and from there back to element 124 (this iterative re-prompting can be carried out any desired number of times in order to try to achieve a valid response at element 124). On the other hand, if, at element 124, the result is “Yes”, then the process continues to element 126 (Save Test Script). Further still, from element 126, the process continues to element 127 (Save Test Script) and from there to element 128 (User Reviews/Edits Automation Script). After element 128, the process ends at element 129.

Still referring to FIG. 1, it is noted that in this embodiment, various elements are carried out by various mechanisms (e.g., software mechanisms) as follows: (a) JIRA—elements 101, 102, 103, 104, 105, 113, 114, 115, 116; (b) API Layer—elements 106, 107, 110, 117, 118, 124; (c) GenAI—elements 109, 111, 121, 123, 125; (d) Database (e.g., MongoDB)—elements 108, 112, 119, 120, 122, 126; (c) Code Repository—element 127; and (f) IDE—elements 128, 129.

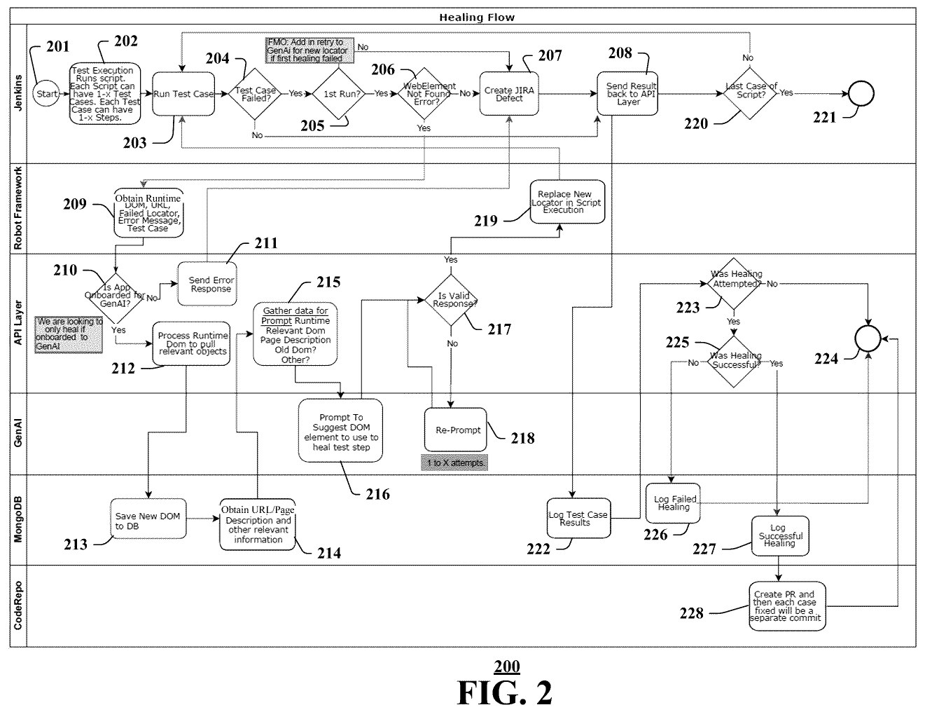

Referring now to FIG. 2, this is a block diagram illustrating an example, non-limiting embodiment of a healing flow process 200 functioning in accordance with various aspects described herein. As seen in this figure, the healing flow process starts at element 201 (Start). The process then continues to element 202 (Test Execution Runs Script (each script can have any desired number of test cases and each test case can have any desired number of scripts)) and from there to element 203 (Run Test Case) and from there to element 204 (Test Case Failed?). If, at element 204, the result is “No”, then the process continues to element 208 (Send Result Back to API Layer). This element 208 is discussed in more detail below. On the other hand, if, at element 204, the result is “Yes”, then the process continues to element 205 (1st Run?). If, at element 205, the result is “No”, then the process continues to element 207 (Create JIRA Defect) and then continues to element 208. On the other hand, if, at element 205, the result is “Yes”, then the process continues to element 206 (Web Element Not Found Error?). If, at element 206, the result is “No”, then the process continues to element 207 and then continues to element 208. On the other hand, if, at element 206, the result is “Yes”, then the process continues to element 209 (Obtain Runtime DOM, URL, Failed Locator, Error Message, Test Case).

Still referring to FIG. 2, from element 209 the process continues to element 210 (Is App Onboarded for GenAI?). If, at element 210, the result is “No”, then the process continues to element 211 (Send Error Response) and then continues to element 207 and 208. On the other hand, if, at element 210, the result is “Yes”, then the process continues to element 212 (Process Runtime DOM to Pull Relevant Objects). The process then continues to element 213 (Save New DOM to DB) and then to element 214 (Obtain URL/Page Description and Other Relevant Information). Further, from element 214 the process continues to element 215 (Gather Data for Prompt (Runtime Relevant DOM, Page Description, Old DOM?, Other?)) and then continues to element 216 (Prompt To Suggest DOM Element to Use to Heal Test Step) and then continues to element 217 (Is Valid Response?).

Still referring to FIG. 2, if, at element 217, the result is “No”, then the process continues to element 218 (Re-Prompt) and from there back to element 217 (this iterative re-prompting can be carried out any desired number of times in order to try to achieve a valid response at element 217). On the other hand, if, at element 217, the result is “Yes”, then the process continues to element 219 (Replace New Locator in Scrip Execution). The process then continues to element 203 (Run Test Case) and the process can iterate further from this point.

Still referring to FIG. 2, the process flow from element 208 (Send Result Back to API Layer) will now be discussed. At element 208, the process flow takes two branches. One branch flows to element 220 (Last Case of Script?). If, at element 220, the result is “Yes”, then the process ends at element 221. On the other hand, if, at element 220, the result is “No”, then the process continues to element 203 (the process can iterate further from this point). In another branch from element 208, the process continues to element 222 (Log Test Case Results) and then continues to element 223 (Was Healing Attempted?). If, at element 223, the result is “No”, then the process ends at element 224. On the other hand, if, at element 223, the result is “Yes”, then the process continues to element 225 (Was Healing Successful?). If, at element 225, the result is “No”, then the process continues to element 226 (Log Failed Healing) and then ends at element 224. On the other hand, if, at element 225, the result is “Yes”, then the process continues to element 227 (Log Successful Healing) and then continues to element 228 (Create PR and then each case fixed will be a separate commit) and then ends at element 224.

Still referring to FIG. 2, it is noted that in this embodiment, various elements are carried out by various mechanisms (e.g., software mechanisms) as follows: (a) Jenkins—elements 201, 202, 203, 204, 205, 206, 207, 208, 220, 221; (b) Robot Framework—elements 209, 219; (c) API Layer—elements 210, 211, 212, 215, 217, 223, 225, 224; (d) GenAi—elements 216, 218; (c) Database (e.g., MongoDB)—elements 213, 214. 222, 226, 227; (e) Code Repository—element 228.

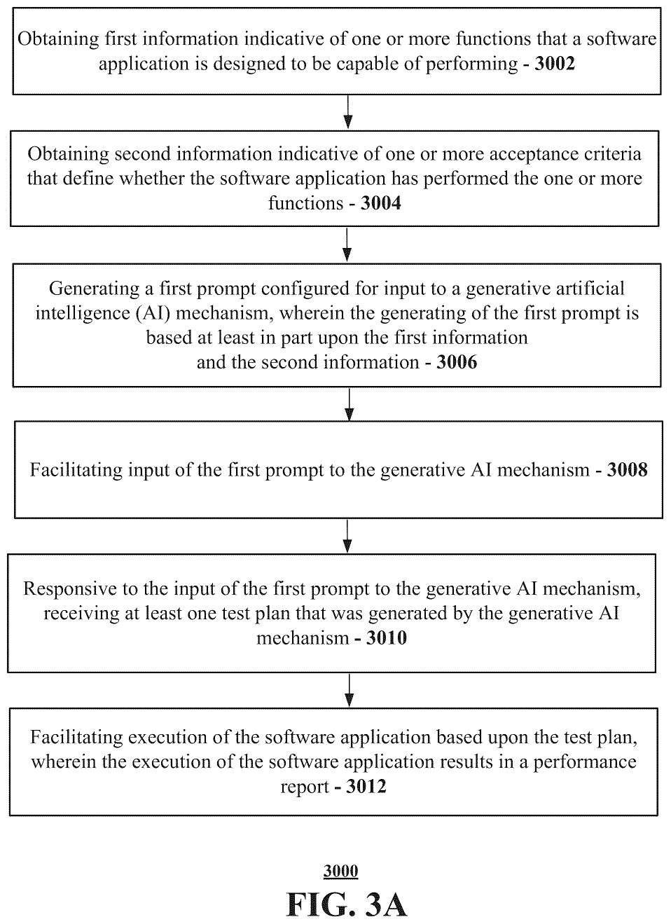

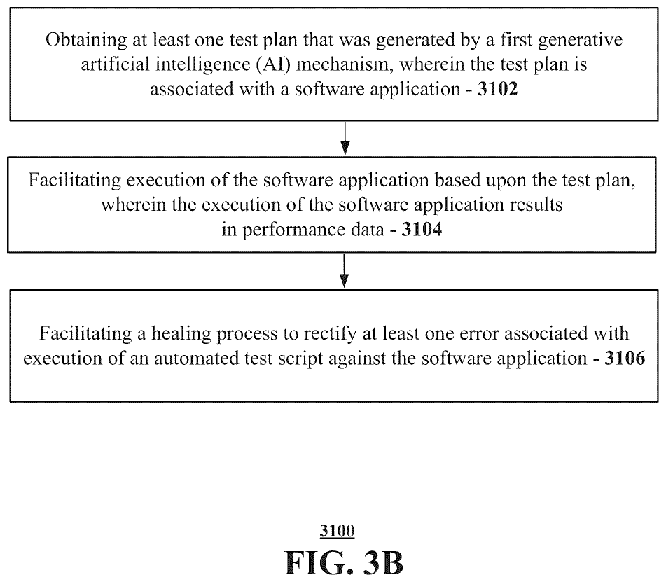

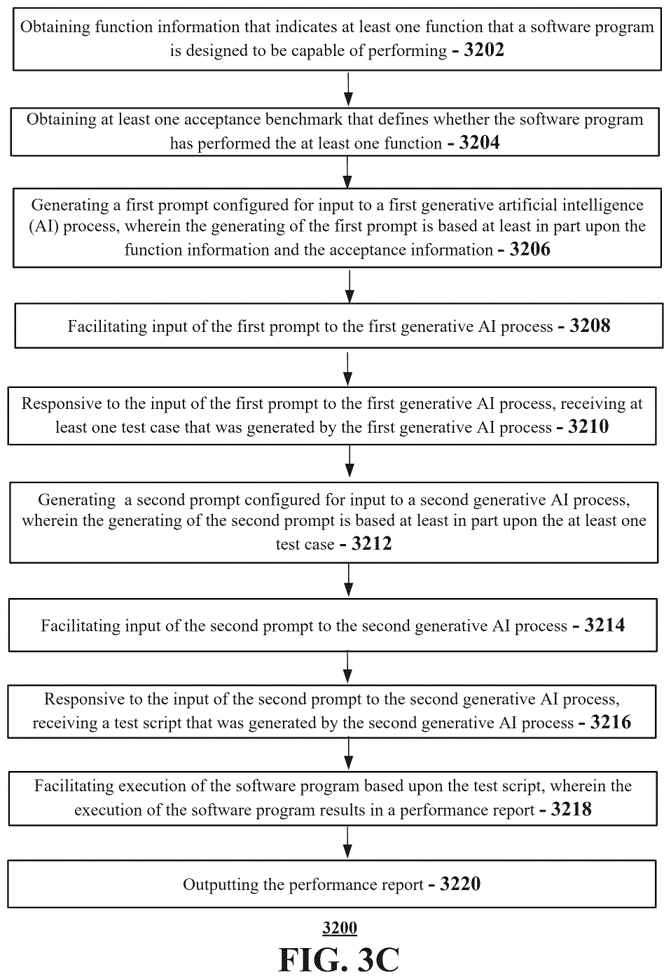

Referring now to FIG. 3A, various steps of a method 3000 according to an embodiment are shown. As seen in this FIG. 3A, step 3002 comprises obtaining first information indicative of one or more functions that a software application is designed to be capable of performing. Next, step 3004 comprises obtaining second information indicative of one or more acceptance criteria that define whether the software application has performed the one or more functions. Next, step 3006 comprises generating a first prompt configured for input to a generative artificial intelligence (AI) mechanism, wherein the generating of the first prompt is based at least in part upon the first information and the second information. Next, step 3008 comprises facilitating input of the first prompt to the generative AI mechanism. Next, step 3010 comprises responsive to the input of the first prompt to the generative AI mechanism, receiving at least one test plan that was generated by the generative AI mechanism. Next, step 3012 comprises facilitating execution of the software application based upon the test plan, wherein the execution of the software application results in a performance report.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 3B, various steps of a method 3100 according to an embodiment are shown. As seen in this FIG. 3B, step 3102 comprises obtaining at least one test plan that was generated by a first generative artificial intelligence (AI) mechanism, wherein the test plan is associated with a software application. Next, step 3104 comprises facilitating execution of the software application based upon the test plan, wherein the execution of the software application results in performance data. Next, step 3106 comprises facilitating a healing process to rectify at least one error associated with execution of an automated test script against the software application, wherein healing process comprises: obtaining first information indicative one or more failed locators associated with the software application; generating a first prompt configured for input to a second generative AI mechanism, wherein the generating of the first prompt is based at least in part upon the first information indicative of the one or more failed locators; facilitating input of the first prompt to the second generative AI mechanism; and responsive to the input of the first prompt to the second generative AI mechanism, receiving at least one new locator that was generated by the second generative AI.

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 3C, various steps of a method 3200 according to an embodiment are shown. As seen in this FIG. 3C, step 3202 comprises obtaining, by a processing system including a processor, function information that indicates at least one function that a software program is designed to be capable of performing. Next, step 3204 comprises obtaining, by the processing system, at least one acceptance benchmark that defines whether the software program has performed the at least one function. Next, step 3206 comprises generating, by the processing system, a first prompt configured for input to a first generative artificial intelligence (AI) process, wherein the generating of the first prompt is based at least in part upon the function information and the acceptance information. Next, step 3208 comprises facilitating, by the processing system, input of the first prompt to the first generative AI process. Next, step 3210 comprises responsive to the input of the first prompt to the first generative AI process, receiving, by the processing system, at least one test case that was generated by the first generative AI process. Next, step 3212 comprises generating, by the processing system, a second prompt configured for input to a second generative AI process, wherein the generating of the second prompt is based at least in part upon the at least one test case. Next, step 3214 comprises facilitating, by the processing system, input of the second prompt to the second generative AI process. Next, step 3216 comprises responsive to the input of the second prompt to the second generative AI process, receiving, by the processing system, a test script that was generated by the second generative AI process. Next, step 3218 comprises facilitating, by the processing system, execution of the software program based upon the test script, wherein the execution of the software program results in a performance report. Next, step 3220 comprises outputting, by the processing system, the performance report.

While for purposes of simplicity of explanation, the respective processes are shown and described as a series of blocks in FIG. 3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments harness the power of generative AI to automatically facilitate: (a) generating of test plans from user stories and acceptance criteria; (b) creating of automation test scripts; and/or (c) healing of errors in the automation test scripts during execution. By leveraging advanced language understanding and contextual analysis, the AI (according to various embodiments) can accurately interpret requirements and produce comprehensive test plans (e.g., that adhere to industry standards).

In various embodiments, after human review and updates, the AI can then utilize test plans to create automation test scripts (further streamlining the testing process). Such an innovative approach (according to various embodiments) not only saves time and resources, but also ensures consistency and minimizes the potential for human error. During automation test script execution, the AI (according to various embodiments) can process errors that happened in the script and suggest a solution for the problem (e.g., so that the script execution can be retried). Furthermore, the AI's ability (according to various embodiments) to adapt to changing requirements makes it a highly efficient and dynamic solution.

As described herein, various embodiments provide healing (e.g., fixing) of a test plan, a test case, and/or a test script. The healing can, for example, supply a missing locator, correct a wrong locator, or any combination thereof. The healing can be carried out, for example, in the context of regression testing.

As described herein, various embodiments provide healing as a result of execution of an automated test script against a software application (whereas, for example, because of changes in the software application, the automated test script failed to run properly (e.g., in a case where the automated test script was not updated to correctly reflect changes that were made in the software application)). In response to such issues, the automated test script would need to be “healed” and updated.

As described herein, various embodiments provide healing wherein a user is notified (or prompted) regarding changes made and/or required.

As described herein, various embodiments can be applied to a user interface (UI) of a software application, a webpage, a website, or any combination thereof. The test script can, for example, launch an application and apply any necessary credentials.

As described herein, various embodiments can be applied to existing software, modified software (e.g., with a changed application structure), and/or new software.

As described herein, various embodiments provide technical benefits including (but not limited to): (a) improved accuracy and efficiency in both test plan and automation test script generation; and/or (b) the ability to quickly adapt to project changes. These benefits can result in a more streamlined development process and faster time to market for software products.

As described herein, various embodiments provide commercial benefits including (but not limited to): (a) significant cost savings (such as due to reduced manual labor); (b) the potential to offer an AI-driven solution as a standalone product and/or service; and/or (c) a competitive advantage for businesses adopting these techniques.

As described herein, various embodiments provide for automating various aspects of Agile software development.

As described herein, various embodiments can be applied by any entity that is developing software with Agile principles and/or that is utilizing an issue-tracking system (such as JIRA) to house their stories and associated acceptance criteria.

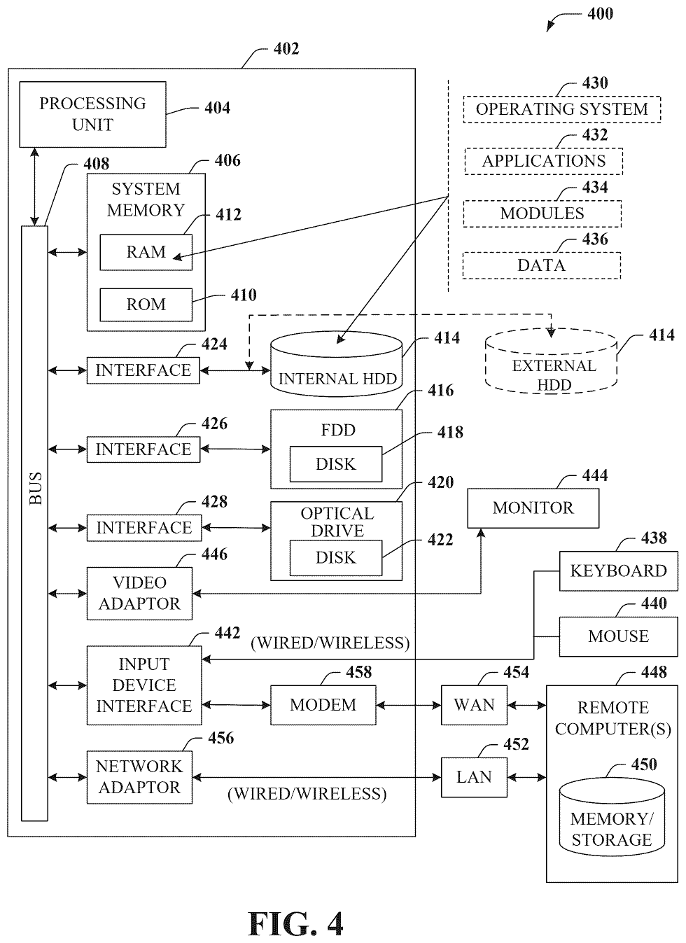

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network element(s), access terminal(s), etc. Each of these devices can be implemented via computer-executable instructions that can run on one or more computers, and/or in combination with other program modules and/or as a combination of hardware and software. For example, computing environment 400 can facilitate in whole or in part testing, validating, and optimizing software.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

As described herein, some of the embodiments can employ artificial intelligence (AI) to facilitate automating one or more features described herein. The embodiments (e.g., in connection with automatically testing, validating, and optimizing software) can employ various AI-based schemes for carrying out various embodiments thereof. Moreover, a classifier can be employed to determine a ranking or priority of each software application, test case, and/or test plan. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the software application(s), test case(s), and/or test plan(s) will receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining first information indicative of one or more functions that a software application is designed to be capable of performing;
obtaining second information indicative of one or more acceptance criteria that define whether the software application has performed the one or more functions;
generating a first prompt configured for input to a generative artificial intelligence (AI) mechanism, wherein the generating of the first prompt is based at least in part upon the first information and the second information;
facilitating input of the first prompt to the generative AI mechanism;
responsive to the input of the first prompt to the generative AI mechanism, receiving at least one test plan that was generated by the generative AI mechanism; and
facilitating execution of the software application based upon the test plan, wherein the execution of the software application results in a performance report.

2. The device of claim 1, wherein the first information comprises a user story in an issue tracking software environment.

3. The device of claim 2, wherein the issue tracking software environment comprises a JIRA environment.

4. The device of claim 1, wherein the acceptance criteria defines: whether the one or more functions have been performed within an allotted time period; whether the one or more functions have been performed within an allotted accuracy; or any combination thereof.

5. The device of claim 1, wherein the test plan comprises a test setup; test data; expected results; or a combination thereof.

6. The device of claim 1, wherein:
the execution of the software application is responsive to operation of a test script; and
the software application comprises a webpage, a website, or any combination thereof.

7. The device of claim 6, wherein the operations further comprise:
generating a second prompt configured for input to the generative AI mechanism, wherein the generating of the second prompt is based at least in part upon the test script;
facilitating input of the second prompt to the generative AI mechanism; and
responsive to the input of the second prompt to the generative AI mechanism, receiving the test script that was generated by the generative AI mechanism.

8. The device of claim 1, wherein the operations further comprise facilitating a healing process to rectify at least one error associated with execution of an automated test script against the software application.

9. The device of claim 8, wherein the healing process comprises:
obtaining third information indicative of one or more failed locators associated with a test script;
generating a third prompt configured for input to the generative AI mechanism, wherein the generating of the third prompt is based at least in part upon the third information;
facilitating input of the third prompt to the generative AI mechanism; and
responsive to the input of the third prompt to the generative AI mechanism, receiving at least one new locator that was generated by the AI mechanism.

10. The device of claim 9, wherein the operations further comprise facilitating another execution of the software application, based upon the at least one new locator, wherein the another execution of the software application results in another performance report.

11. The device of claim 9, wherein the at least one new locator is associated with a document object model (DOM).

12. The device of claim 1, wherein the operations further comprise outputting the performance report.

13. The device of claim 1, wherein the input of the first prompt comprises directly inputting the first prompt to the generative AI mechanism, inputting the first prompt to the generative AI mechanism via one or more interfaces, or any combination thereof.

14. The device of claim 1, wherein the generative AI mechanism comprises a large language model (LLM).

15. A non-transitory machine-readable medium comprising executable instructions that, when executed by a processing system including a processor, facilitate performance of operations, the operations comprising:
obtaining at least one test plan that was generated by a first generative artificial intelligence (AI) mechanism, wherein the test plan is associated with a software application;
facilitating execution of the software application based upon the test plan, wherein the execution of the software application results in performance data; and
facilitating a healing process to rectify at least one error associated with execution of an automated test script against the software application, wherein the healing process comprises:
obtaining first information indicative of one or more failed locators associated with the software application;
generating a first prompt configured for input to a second generative AI mechanism, wherein the generating of the first prompt is based at least in part upon the first information indicative of the one or more failed locators;
facilitating input of the first prompt to the second generative AI mechanism; and
responsive to the input of the first prompt to the second generative AI mechanism, receiving at least one new locator that was generated by the second generative AI mechanism.

16. The non-transitory machine-readable medium of claim 15, wherein the operations further comprise facilitating another execution of the software application, based upon the at least one new locator, wherein the another execution of the software application results in other performance data.

17. The non-transitory machine-readable medium of claim 15, wherein the operations further comprise:
obtaining second information indicative of one or more functions that the software application is designed to be capable of performing;
obtaining third information indicative of one or more acceptance criteria that define whether the software application has performed the one or more functions;
generating a second prompt configured for input to the first generative AI mechanism, wherein the generating of the second prompt is based at least in part upon the second information and the third information; and
facilitating input of the second prompt to the first generative AI mechanism.

18. The non-transitory machine-readable medium of claim 15, wherein the first generative AI mechanism is a same generative AI mechanism as the second generative AI mechanism.

19. A method, comprising:
obtaining, by a processing system including a processor, function information that indicates at least one function that a software program is designed to be capable of performing;
obtaining, by the processing system, at least one acceptance benchmark that defines whether the software program has performed the at least one function;
generating, by the processing system, a first prompt configured for input to a first generative artificial intelligence (AI) process, wherein the generating of the first prompt is based at least in part upon the function information and the benchmark;
facilitating, by the processing system, input of the first prompt to the first generative AI process;
responsive to the input of the first prompt to the first generative AI process, receiving, by the processing system, at least one test case that was generated by the first generative AI process;
generating, by the processing system, a second prompt configured for input to a second generative AI process, wherein the generating of the second prompt is based at least in part upon the at least one test case;
facilitating, by the processing system, input of the second prompt to the second generative AI process;
responsive to the input of the second prompt to the second generative AI process, receiving, by the processing system, a test script that was generated by the second generative AI process;
facilitating, by the processing system, execution of the software program based upon the test script, wherein the execution of the software program results in a performance report; and
outputting, by the processing system, the performance report.

20. The method of claim 19, wherein the first generative AI process is different from the second generative AI process.
